(19) United States
(12) Patent Application Publication
(10) Pub. No.: US 2018/0248962 A1
(43) Pub. Date: Aug. 30, 2018

(54) Social Network System and Method Based on User Selected Geographic Locations

(71) Applicant: Granavathanan RAPHAEL MAHARAJAH, Toronto, Ontario (CA)

(72) Inventor: Granavathanan RAPHAEL MAHARAJAH, Toronto, Ontario (CA)

(21) Appl. No.: 15/732,498

(22) PCT Filed: Dec. 12, 2014
(86) PCT No.: PCT/IB2014/066853

§ 371 Date: Nov. 21, 2017

(51) Int. Cl. H04L 29/08; G06Q 30/02; G06Q 50/00

(52) U.S. Cl. CPC H04L 67/18; H04L 51/32; G06Q 50/01; G06Q 30/0203

(57) ABSTRACT

A novel system and method for establishing a social network based on user selected geographic locations. In a preferred embodiment, a registered user selects one or more geographic locations from actual locations around the world. The user then joins specific neighborhoods/communities or interest groups within the selected locations to share personal experiences. Interactions between the registered user and others are based on mutual topics of interest specified by the selected geographic location(s) and interests. Interactions include notifications, posts and discussions. The registered user can also access information such as weather, calendars, advertisements, job banks, personal ads and RSS feeds that are specific to the selected geographic location(s) and interests. The system allows registered users to participate in polls, surveys and questionnaire specific to the selected geographic location(s) and interest groups.

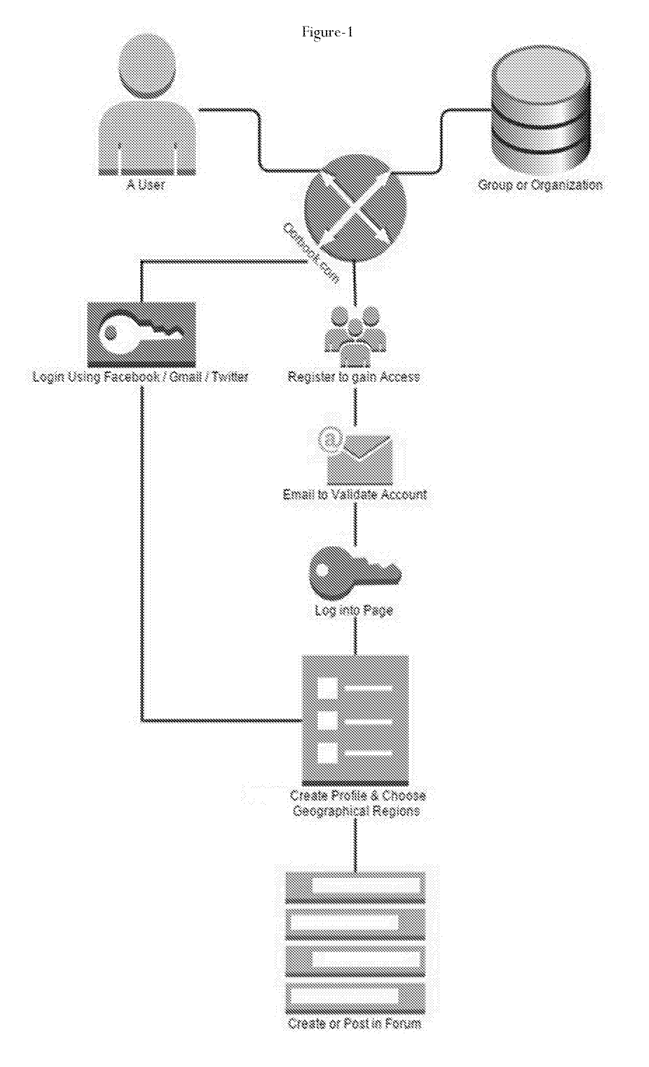

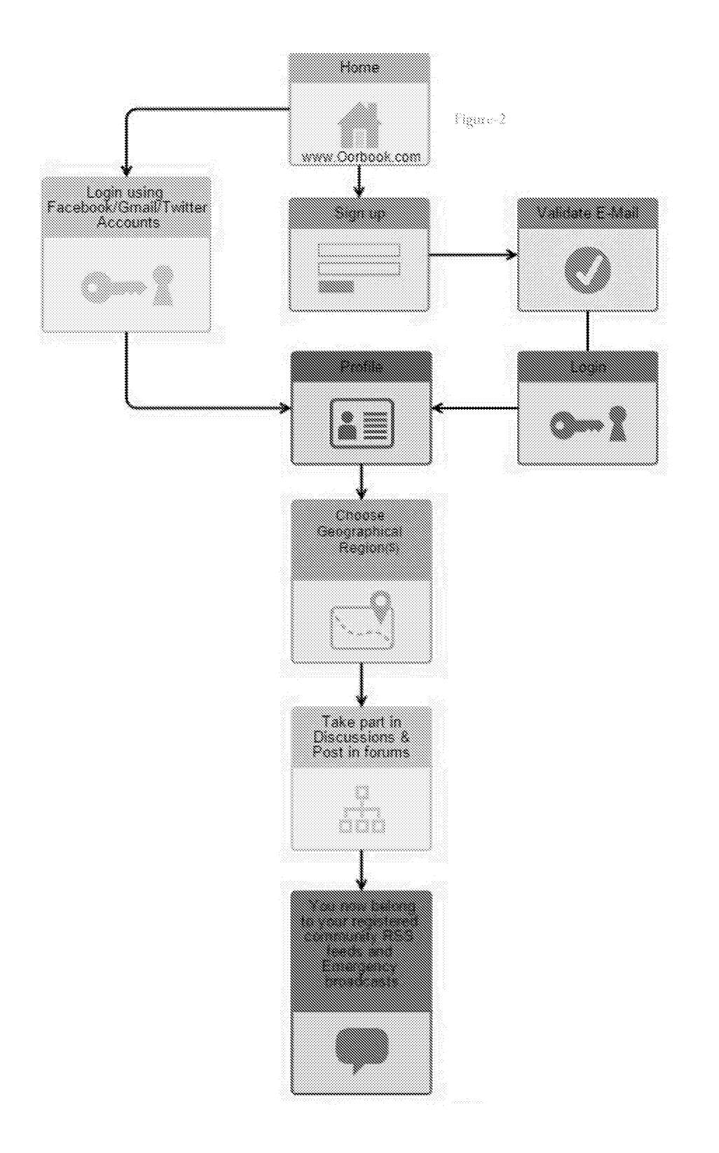

### DETAILED DESCRIPTION OF THE INVENTION

Oorbook is a geographic based social networking platform. In reference to the structure chart, the use of the invention is accomplished by the user in distinct phases.

Registration Phase:

Users will register for the site directly and then verify their email addresses before logging in. The registration phase will create a profile for the user who can then use it for all Oorbook geographic based functionalities.

Profile Setup Phase:

After registration, the users set their geographic location(s) which will also determine what the users see after logging into the site in regards to weather, calendar, ads, job bank, personal ads and RSS functionalities. In addition to their geographic locations, users will subscribe to their preferred interest groups which will also determine what possible notifications they may receive to their profile in regards to those specified interest groups.

Topic Creation and Posting Phase:

Once the registration and profile setup phases are completed, users can begin to create topics and post in existing topics in regards to their preferred interest groups. The users who have set the same geographic locations can then view these topics and these posts.

### DESCRIPTION OF PURPOSE AND FUNCTIONALITY OF INVENTION

With Oorbook, the users are limited in regards to what ads, notification, weather, job bank and RSS they can see by the geographic locations that they have chosen. This ensures that the purpose of Oorbook is committed to building and strengthening of local communities. With Oorbook, even a small village can have its own location where its members can post and create topics without having to create the village's own website. Political organizations, government bodies and business groups can then use it to send notifications, conduct opinion polls for research or surveying purposes, and interact with community members who have subscribed to that geographic location group. Community organizers will even have the ability to create private discussion topics open only through invitation. This would even allow small business groups to have their own communication web where they can communicate with their employees and employers internally in regards to their geographic location(s).

### Description of Social Benefits of Invention

With Oorbook, users are communicating with individuals that are in their immediate area or geographic area of interest. The discussions and postings in all the interest groups will be between people who have a vested interest in that locality or ‘geographic location’. The interaction between users in similar geographic locations allows them to see each-other more as neighbors and part of the same community. Users can post events or reminders in calendars in regards to an interest group or topic/subtopic to allow all participants therein to see such reminder or event. Government based groups can issue community wide notifications and research groups can conduct community wide polls, notifications and discussions.

### Description of Economic Value of Invention

Oorbook allows users to upload their resumes and qualifications to their profile and to view job postings. Oorbook also allows employers to view resumes and profiles, and post job availabilities. With Oorbook, the Ads that the site displays will be directly related to the community.

Oorbook can also increase productivity of small business groups that do not have their own websites. The businesses can post community wide notifications for other interest groups. In addition, the business can also create topics that are available to be viewed and posted in only by invitation to ensure it remains internal.

### Description of Cultural Value of Invention

Since Oorbook's functionality revolves around geographic locations, members will have an experience in their desired interest groups and geographic locations that caters to their culture. Interests such as music, television and other entertainment will be localized to geographic locations in the local language.

### Description of Structure Chart Illustration

The Person in the chart represents a user and the cylinder a group or organization. The circle with the red X is oorbook.com.
Both user and group can visit Oorbook as shown with the arrows pointing towards it. Once there, they need to register at which point they will be required to verify their email addresses.
Once verified, the users can login and set up their profile.
The user will then set his/her geographic location(s). At this point, the user can see the weather, calendar, geographic specific ads, job bank, personal ads and RSS.
The user can also then set his/her interest group after choosing his/her geographic location.
At this point, the user can create topics within interest groups and sub topics within them.
The user can also post in existing topics.
The user can take action on any existing topic, events, notifications, discussion.

1. Oorbook: A social networking platform that specifically focuses on users' experience into specific geographic locations that they choose.
a. The number of geographic locations is limited in number.
b. The content that the user sees is directly related to his/her geographic location(s) and interest groups.

2. Oorbook: A social networking platform requiring registration that lets users see notifications, posts and discussions from government, businesses, and social groups.
a. The notifications, discussions, posts and ads that the user can see are specified by their geographic location(s) and interests.

3. The specified geographic location(s) of users allows them to see weather, calendar, ad, job bank, personal ad and RSS that are specific to those locations.

4. Oorbook allows polling and surveys and other questionnaires specific to geographic location(s) and interest groups to be setup up by community groups for community members and those with a vested interest in that geographic location to participate in such polls, surveys and questionnaire.
